(19) United States
(12) Patent Application Publication
(10) Pub. No.: US 2009/0211163 A1
(43) Pub. Date: Aug. 27, 2009

(54) Heat Resistant Insulation Seal for Mine Doors and Accesses

(76) Inventor: Stirl R. Smith, Hurricane, WV (US)

Correspondence Address: MEREK, BLACKMON & VOORHEES, LLC, 673 S. WASHINGTON ST., ALEXANDRIA, VA, 22314, US

(21) Appl. No.: 12/390,563

(22) Filed: Feb. 23, 2009

Related U.S. Application Data
(60) Provisional application No. 61/030,680, filed on Feb. 22, 2008.

(51) Int. Cl. E06B 7/16

(52) U.S. Cl. 49/475.1

(57) ABSTRACT

An improved seal for a mine door. According to a preferred embodiment of the invention, a heavy weight woven glass fiber sheet is attached to a heavy rubber backing. The enhanced sealing and fire resistance of the seal can provide air flow control in a mine while being able to survive the hazardous environment of the mine.

### CROSS REFERENCE TO RELATED APPLICATIONS

This application claims the benefit of U.S. Provisional Application 61/030,680, filed Feb. 22, 2008, which is incorporated herein by reference.

### BACKGROUND OF THE INVENTION

1. Field of the Invention

The present invention relates to a seal for mines for use on doors and other accesses to the mine.

2. Description of the Prior Art

Coal mines and other mines have a number of doors and accesses that must be sealed to control air flow through passageways through the mine and for other reasons, while allowing personnel and machinery to travel through the access when necessary. Often these doors are provided in pairs to act as air locks. For example, Title 30 of the Code of Federal Regulations (“30 CFR”) section 75.333 (d)(3) requires that non-personnel doors that are used to control ventilation be “Installed in pairs to form an airlock. When an airlock is used, one side of the airlock shall remain closed. When not in use, both sides shall be closed.”

The environment of the mines is often dynamic and the forces on the doors can be extreme. Several attempts have been made to improve the doors and door frames to withstand the compressive loads that may occur when the mine walls shift or for other forces inherent in the mining environment. One such patent is RE 36,853 to Kennedy et al. showing an adjustable door frame and reinforcement of the upper lintel and/or the door itself.

Another variable in the mine is heat. Heat can occur from explosions or from other causes within the mine. During explosion or other pressure build up within the mine, the air forced outward will be resisted by the door ways. These doors may include mine doors, machine doors, man doors and other access control doors. The doors must be able to withstand both the heat and pressure that can be generated in these environments. Title 30 CFR §75.333 (d)(1) requires that doors, other than personnel doors (“man doors”) be “Made of noncombustible material or coated on all accessible surfaces with flame-retardant materials having a flame-spread index of 25 or less, as tested under ASTM E162-87, “Standard Test Method for Surface Flammability of Materials Using A Radiant Heat Energy Source.”

While this noncombustibility test is not a problem for the doors themselves, as they are made of metal, it can be a problem for components of the door. Namely, the doors themselves often have seals around the door to further help control air flow across the doorway. In the past, doors have incorporated rubber from conveyor belts having a width of zero to six inches or greater. However, under the new regulations (30 CFR 75.333(d)(1)) this is no longer acceptable. While a single vendor has been cited as making a fire retarded neoprene belt that meets the requirement, any material that does not meet the test used in construction of an airlock door or equipment door will not be accepted. Additionally all other old conveyor belting must be replaced.

It is therefore needed a new material that can provide the sealing ability of the old conveyor belt, while meeting the new noncombustibility requirements. The material should also be cost effective and have the structural integrity necessary to work in the environment needed. The material must also have the ability to withstand traffic or other forces on the material incurred during normal use.

### SUMMARY OF THE INVENTION

Accordingly, it is a principal object of a preferred embodiment of the invention to provide a new and improved mine door having a noncombustible seal.

It is another object of a preferred embodiment of the invention to provide a door or airlock that has an overall noncombustibility in compliance with federal regulations.

It is a further object of a preferred embodiment of the invention to provide an improved door having flame retardant materials, while providing air flow control capability.

Still another object of a preferred embodiment of the invention is to provide an improved fire resistant air seal around a mine door capable of withstanding long term wear.

It is yet another object of a preferred embodiment of the invention to provide a roll up door made of fire resistant material that can provide air flow control.

It is an object of a preferred embodiment of the invention to provide improved elements and arrangements thereof in an apparatus for the purposes described which is inexpensive, dependable and fully effective in accomplishing its intended purposes.

These and other objects of preferred embodiments of the present invention will be readily apparent upon review of the following detailed description of the invention and the accompanying drawings. These objects of the present invention are not exhaustive and are not to be construed as limiting the scope of the claimed invention. Further, it must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

### BRIEF DESCRIPTION OF THE DRAWINGS

FIG. 1 is front environmental view of a set of mine doors according to one aspect of the invention.

FIG. 2 is a perspective view of a sheet of silicone rubber and glass fiber according to one aspect of the invention.

FIG. 3 Is a perspective view of a portion of a roll up door according to a further aspect of the invention.

FIG. 4. is a perspective view of a door according to an aspect of the invention.

FIGS. 5A and 5B are environmental views of regulator doors according to a further aspect of the invention

FIG. 6 is a perspective view of a gasket according to an aspect of the invention.

FIG. 7 is an alternative perspective view of a gasket according to an aspect of the invention.

Similar reference characters denote corresponding features consistently throughout the attached drawings.

### DETAILED DESCRIPTION OF THE PREFERRED EMBODIMENT(S)

The present invention according to one embodiment of the invention is to an improved mine door or an air control device in a similar hostile or potentially high temperature environment.

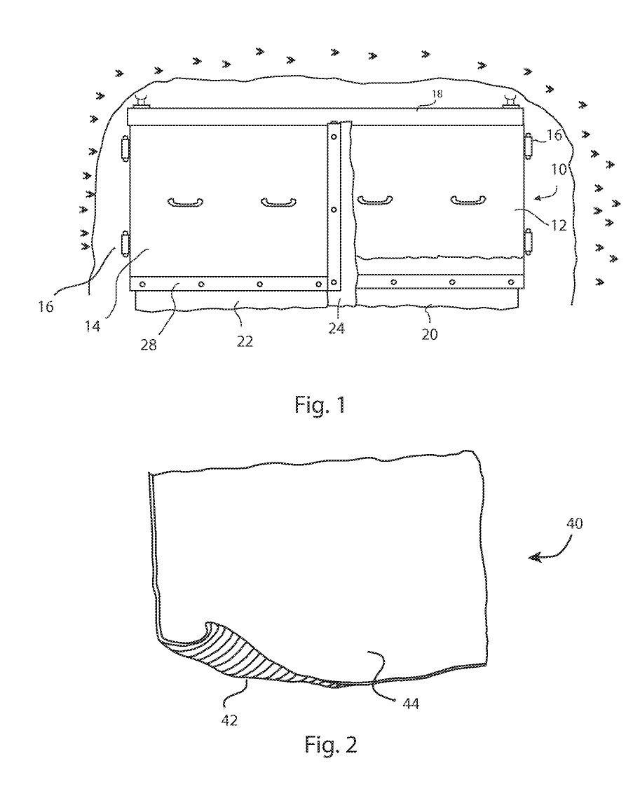

FIG. 1 shows a set of mine doors and frame 10 for closing a passage in a mine. The doors may be airlock doors, equipment doors, air regulators, personnel doors or the like. These doors may be in the main air course of a coal mine (intake or return) or may be used to seal auxiliary passages so that the air flow through the main air course are not diverted.

Mines that are dug through earthen structure typically have no ventilation of their own. For personnel to work in the harsh environment of mines, especially coal mines and the like, it is necessary to add elaborate ventilation. This is necessary not only for the personnel to have air to breath, but also to move combustible products such as methane and coal dust out of the mine to the surrounding environment where they can be dissipated. In a typical mine, a main air course consists of an intake having a high power blower air source, and a return for expelling the air and any entrained gases or other products. Additional passageways may be built through the mine to carry men, equipment and/or the mined product, such as coal. To direct air throughout the whole mine, it is important that these additional passageways to not divert the air before it has run its course. Therefore, these other passageways have air blocks. To allow the personnel and equipment and other items to pass into and out of the mine, the air blocks typically take the form of doors. Often, as described above, the doors are in pairs such that there is always at least one device blocking air from substantially diverting through a passage.

Because of the number of doors and the environment, the doors themselves must be made to incorporate substantial structural integrity. Typically the doors are made of steel or a similar material. To effectively seal with each other and to reduce the amount of air escaping past the air blocks, additional seals are used on the doors. These seals must be able to withstand the heat of fires and explosions without fouling the air and without adding fuel to the fires. Normal, everyday rubber that is found on car doors and the like would not last in the mines and would violate the regulations discussed above for at least the reason that they are flammable. In the past, conveyor belt material has been used. These materials are very rigid and are very rugged. However, the conveyor belt material can be so rigid that it actually interferes with the operation of the door by catching on the floor of the mine or other impediments. What is needed is a flexible material that helps seal the area around the door, while specifically suited to the harsh environment of the mines and complying with the regulations for materials in a mine.

Referring to FIGS. 1 and 4, there is shown an improved door system 10 for a mine. The door system may comprise two doors 12, 14 swinging on a number of hinges 16 to fold in to each other, but the number of doors is not critical to the invention. A lintel 18 may be provided at an upper edge of the door system to support the door system and to aid in sealing the top of the door system with the mine. While a large gap is shown around the door way with the mine for clarity, it is understood that the door system can be sized to fit the passageway and materials can be used to seal the space around the door system, including the seals discussed hereinunder.

Along a portion of the periphery of the door are provided seals, for example, at 20, 22, 24. The seals may be secured to the doors by clamps 28 bolted to the door or may be secured to the door by other means. The left outer door has a bottom seal 22 and an overlap seal 24. The right door has a bottom seal 20, and may have an overlap seal, but preferably only one door has an overlap seal for sealing between the doors. The bottom seals seal with the frame (not shown) of the door or with the floor of the mine or passage way are thus both helpful to the door. The length of the seal may be chosen for the application or proportional to the size of the door, etc. While the vertical and horizontal seals of door 14 have been shown as separate pieces, the seals could be constructed as one unitary piece. Additionally, one seal could be cut that surrounds the entire door. The overall shape could be the made to cover the entire door or any portion thereof. The shape of the seal is also not limited to fit one surface of a square door, and could also be gasket shaped (“round”) or any other shape and/or size necessary to seal the intended area. In practice, it may also be desirable to seal other surfaces of the door than shown in FIG. 1. A seal could be used to seal the upper surface of the door against the header, and to seal on the hinge side of the door(s) to prevent air leaks between the door and the column.

The seal is preferably made from a fiber glass and silicone rubber material. One such material is PYROBLANKET 96™ sold by ADL INSULFLEX™ for use as a molten metal splash blanket. As shown in FIG. 2, the seal material 40 has woven glass fiber 42 on one side and a heavy coating of silicone rubber 44 on the other side. The woven fiber, as opposed to blown fiber, allows the material to have the consistency of khaki pants, keeping the fibers intact with each other and giving it similar structural properties of cloth so that it does not tear or unravel during use, especially when one side has been treated with the silicone rubber. Other weights and combinations of fiber glass and silicone rubber could be used, but the thickness and heat resistance of approximately 96 ounce per yard material has been found to be desirable. Additionally, the rubber coating could applied to both sides of the woven fiber to increase weight of the blanket, to provide a sacrificial coating or for other reasons. The material can also be tubular, like a hose, for example, to fit over parts or to better fill a gap. The seal could also be gasket shaped (namely a substantially circular or oval cross section with optionally an extending connecting flange as shown in FIGS. 6 and 7) to provide more sealing cross section, while remaining compressible for adaptability. More than one sheet of the seal material can be used at one location or can be joined together serially or in parallel to change the shape or size of the seal to alter its effective sealing ability. One sealing sheet could also comprise multiple alternating layers of glass fiber and silicone rubber, or could be combined with additional layers to provide additional properties to the sheets for stiffening, etc.

Other materials could be used in place of the glass fiber, such as carbon fiber or NOMEX with satisfactory results. However, these materials will produce a more rigid seal, which may not be desirable in some circumstances, and are typically more expensive to produce or procure.

The weight and the fire or heat resistance of the material is related to the amount of silicone rubber on the woven fiber. This can be measured by the weight of the material, for instance the number of ounces (weight) per square yard of material. It has been found that PYROBLANKET 96, which weighs 96 ounces per square yard and has a short term heat resistance capable of withstanding 3000 F is a suitable material for the doors. The material also has a continuous heat resistance at 500 F. The material also has been tested for use on a mine door to have an average flame spread resistance (“radiant panel index”) of 15 or less for the silicone rubber material and an index of 0 for the fiberglass blanket side. This is well within the flame spread index of 25 specified by 30 CFR 75.333(d)(1). During a fire or explosion in a mine, the material is likely to maintain its structure, or even during failure, the material will only degrade to its component materials, namely silicone in a sand like form. It will not release the noxious vapors of a rubber such as that used in tires and the like.

The weight of the material adds structural integrity to the material without having the rigidity of a conveyor belt material that might interfere with operation of the door. The weight and rigidity can be compared to a commercial floor mat found in many shops and restaurants. The flexibility also allows the seal to conform better to and mate with the surfaces that the seal contacts resulting in improved sealing of the doors. The material can be easily trimmed using commercial shears to the proper dimensions and bolted or clamped to the doors. The material can also be rolled up for easy shipping or for use as a roll up door material.

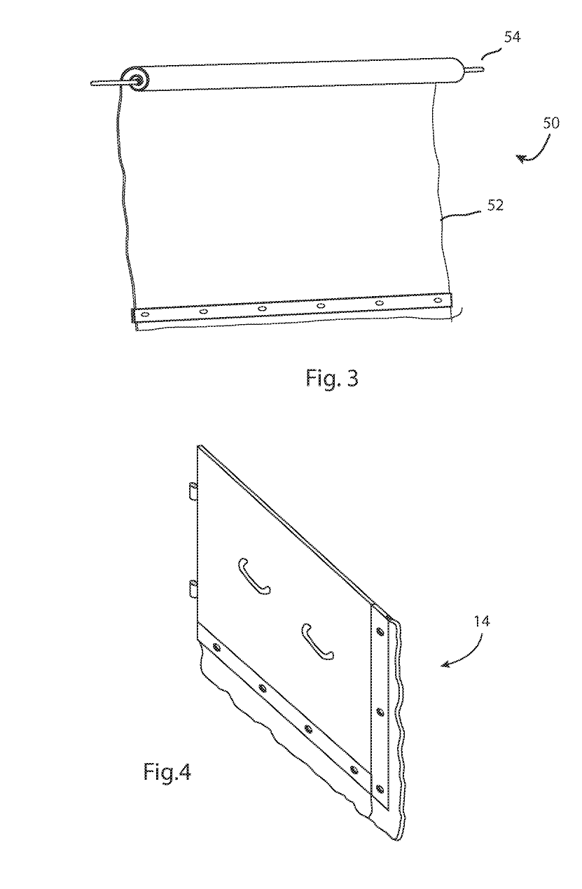

FIG. 3 shows a roll up door 50 designed to fit in a passageway in a mine and replace a rubber roll up door. The roll up door comprises a sheet or multiple sheets of glass fiber (or carbon fiber or NOMEX) and silicone rubber to form a roll up curtain. An activating rod 54 can be connected to a motor or chain pull to cause the rod to rotate and thereby roll the curtain up clearing the passageway or rotated in the opposite direction unrolling the curtain to block the passageway. A weight or clamp 56 may be provided at a lower edge to give form to the door and to help the door lower to the correct position under the force of gravity. Additional or alternative support could also be used on the door including tracks to maintain the door in the proper orientation to the door way. In a further preferred embodiment, two sheets of glass fiber and silicone rubber can be attached or manufactured together with the fiber glass layers facing together. By stitching or otherwise joining the two sheets together with the fiber glass layers on the interior, the curtain can be constructed having the more durable rubber faces are presented outwardly on both sides. The heftier curtain made from two (or more) sheets also will have better structural properties allowing the door to seal better and raise and lower easier as discussed above.

The door system operating as shown in FIG. 1 is vastly improved over prior door systems because of the improved flexibility of the fiber glass and silicone rubber seal. In the preferred embodiment, the heavier weight fiber glass and silicone rubber seal is used on the door, however, in appropriate environments, lower weight materials could be used such as 17 oz or 32 oz per square yard sheets. The door with the improved seal is easier to operate because of the flexibility and seals better because of the ability of the seal to flex in place. The door system is also safer because of the increase heat resistance and flame resistance index. The door system is also improved because of the removal of any noxious fumes caused by previous door seals. The door system is thusly greatly improved over prior doors and increases safety to the mine and to the personnel therein, especially during an adverse situation such as a fire or explosion. The use of alternative materials in place of the glass fiber such as silicone rubber coated NOMEX or carbon fiber can also be used, but would likely have higher rigidity and higher costs.

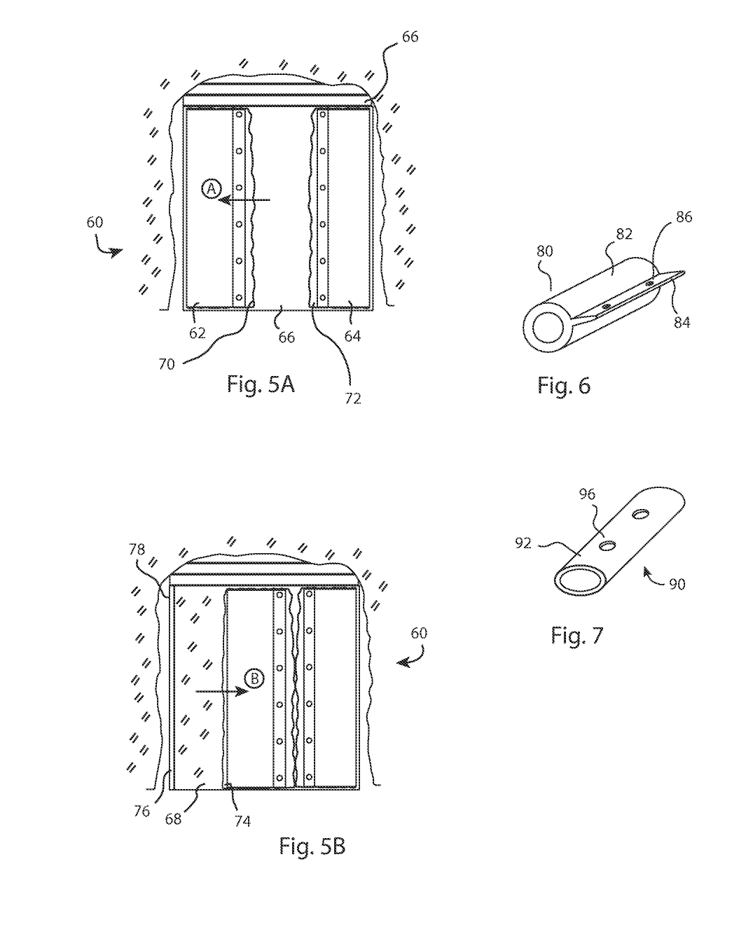

FIGS. 5A and 5B show sliding air regulator doors are shown using the principles of the invention. Three panels 62,64,66 are shown sealing a passage way. A header 66 is shown with appropriate structure to block the area above the door. One or more of the panels may be selectively slid to block or uncover parts of the passageway. The left door 62 is shown having been moved to position A in FIG. 5A blocking the passage way. In FIG. 5B is shown slid over a portion of panel 66 to position B, thereby forming an opening 68 in the passage. Seals 70,72 are provided at the interface between the regulator doors and the panel 66. Additional seals 74 may provide a seal between any of the sliding doors 62 and the door frame including column 76. A seal may also be provided as a gasket surrounding a portion of or the entire sliding panel. As shown in FIGS. 6 & 7, the seal could be in the form of a gasket having shapes other than flat. FIG. 6 shows a glass fiber and silicone rubber seal 80 in the form of a gasket. The compressible cylindrical body 82 can be compressed between two surfaces (not shown) to form a seal. A flange 84 may be provided to secure the seal to a surface by clamping the flange to a surface and to seal the gasket to the surface. Holes 86 may be provided to attach the gasket to a surface by appropriate bolts or the like. FIG. 7 shows an alternative arrangement of the seal 90 having a round, cylindrical body 92 with holes 96 for receiving a bolt or the like to seal the seal 92 to at least one surface.

A seal 78 can also be provided between the door frame, such as shown along column 76, and the mine walls or along panels (not shown) surrounding the door system to seal the door system 60 with the mine walls.

Other areas of a mine could also benefit from such door seals, such as air controls including, check curtains, seals around door frames, other areas of the door, any seal applications in the main air course of a coal mine (intake & return), overcast, undercast, shaft partitions, permanent stoppings, and other permanent ventilation control in the air course of a coal mine. The seals used herein can also find application in other areas susceptible to fire and/or explosion, where air flow control regulation is also an important design criteria.

Additionally, the seals can be added to existing doors by clamping the seals to the existing doors in the manner shown in FIG. 1 for doors not previously having seals. The seals could be attached also by adhesive, bolts with large flange washers attached to prevent the bolt from pulling through or by other means, however, clamps provide the easiest method of maintaining large portions of the seal trapped in place to ensure that the seal stays in place. Additionally, the clamps ensure that at least one end of the seal is secured sealed to the door in a near air tight manner.

Mine doors having other types of seals can be retrofitted to use the current seals by cutting or manufacturing the seals in the desired shape, removing the old seals and clamping the new seals in place. Where necessary, clamping plates or replacement bolts having the proper shape and size may replace any older plates or bolts as necessary. In a similar way, seals made from fiber glass and silicone rubber can be replaced when they are worn by removing the old seals and adding the new seals in their place. Additionally, doors having some seals can have additional seals of the sheet type or gasket type added to the doors in a similar fashion. In any place where a sheet type seal has been specified, it may be possible to replace with a gasket or with a compressed tubular seal or other shape or combination of seals without venturing from the teachings of this invention where a different shape would help seal a particular gap or junction. The replacement of prior seals with the new glass fiber (or carbon fiber or NOMEX or the like) and silicone (or the like) rubber seals provides a safer, more flexible and more adaptable door than was possible using past seals, including conveyor belt materials.

While this invention has been described as having a preferred design, it is understood that it is capable of further modifications, uses and/or adaptations of the invention following in general the principle of the invention and including such departures from the present disclosure as come within the known or customary practice in the art to which the invention pertains and as maybe applied to the central features hereinbefore set forth, and fall within the scope of the invention and the limits of the appended claims. It is therefore to be understood that the present invention is not limited to the sole embodiment described above, but encompasses any and all embodiments within the scope of the following claims.

I claim:

1. A door comprising:
a first, substantially planar surface and a perimeter around said first planar surface;
a seal affixed to at least a portion of said planar surface;
said seal includes a fire resistant material selected from the group consisting of woven glass fiber, NOMEX, carbon fiber, and PYROBLANKET.

2. The door of claim 2, wherein said seal further comprises a rubber backing behind said seal to increase the air impermeability of said seal.

3. The door of claim 2, wherein said seal is formed of a woven glass fiber and rubber material, said woven glass fiber having a weight of at least 96 ounces per square yard and having a short term heat resistance capable of withstanding at least 3000 F.

4. The door of claim 2, wherein said seal further comprises a rubber backing behind said seal to increase the air impermeability of said seal, wherein said rubber backing extends the entire length and width of said seal.

5. The door of claim 2, wherein said seal has a weight of at least 17 ounces per square yard.

6. The door of claim 2, wherein said seal has a weight of at least 32 ounces per square yard.

7. The door of claim 2, wherein said seal has a weight of at least 96 ounces per square yard.

8. The door of claim 2, wherein said a fire resistant material selected from the group consisting of woven glass fiber.

9. The door of claim 2, wherein said a fire resistant material selected from the group consisting of woven glass fiber.

10. A mine door for installation in a passageway in a mine formed by a door frame installed in the passageway of a mine, said mine door comprising:
a door frame adapted to be hingedly attached to the door frame and installed in the passageway to define a doorway;
a mine door having a generally planar surface fabricated from metal and a perimeter surface surrounding said planar surface; and
a seal mounted on at least one planar or perimeter surface of the mine door, said seal being formed of woven glass fiber attached to a rubber backing.

11. A mine door for installation in a passageway in a mine formed by a door frame installed in the passageway of a mine, said mine door including a seal formed of woven fiber attached to a rubber backing.

12. The mine door of claim 11, wherein said woven fiber is a woven glass fiber.

13. The mine door of claim 11, wherein said woven fiber is a woven glass fiber.

14. The mine door of claim 11, wherein said seal is formed by a sheet of woven glass fiber mounted to a sheet of rubber of substantially equal size to the woven glass fiber sheet.

15. The mine door of claim 11, wherein said seal is formed by a sheet of woven glass fiber mounted between two sheets of rubber of substantially equal size to the woven glass fiber sheet.

16. The mine door of claim 15, wherein woven glass sheet and said two sheets of rubber are stitched together.

17. The mine door of claim 11, wherein mine door is a retractable curtain which can be rolled down to seal an area defined by the door frame.

18. The mine door of claim 11, wherein mine door is slidable to seal an area within said door frame.
